(19) United States
(12) Patent Application Publication
(10) Pub. No.: US 2007/0229733 A1
(43) Pub. Date: Oct. 4, 2007

(54) LIQUID CRYSTAL DISPLAY, PANEL FOR THE SAME AND METHOD OF MANUFACTURE

(76) Inventors: Duck-Jong SUH, Seoul (KR); Nam-Seok Lee, Suwon-si (KR); Jeong-Uk Heo, Seongnam-si (KR); Kyong-Ok Park, Bucheon-si (KR); Baek-Kyun Jeon, Yongin-si (KR); Yong-Kuk Yun, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/695,732

(22) Filed: Apr. 3, 2007

(30) Foreign Application Priority Data
Apr. 3, 2006 (KR) 10-2006-0030088
Sep. 14, 2006 (KR) 10-2006-0089046

(51) Int. Cl. G02F 1/1335

(52) U.S. Cl. 349/96

(57) ABSTRACT

A display panel includes a pair of substrates separated by a liquid crystal layer, a polarization layer formed on one of the substrates, a color filter formed on the polarization layer, and a common electrode formed on the color filter wherein, the polarization layer substitutes for the conventional black matrix so that when the substrates are sealed together ultraviolet rays used to harden the sealant are not blocked by the black matrix.

### CROSS-REFERENCE TO RELATED APPLICATION

This application claims priority to and the benefit of Korean Patent Application No. 10-2006-0030088 and 10-2006-0089046 respectively filed in the Korean Intellectual Property Office on Apr. 3, 2006 and Sep. 14, 2006, the entire contents of which are incorporated herein by reference.

### BACKGROUND OF THE INVENTION

1. Field of the Invention

The present invention relates to a liquid crystal display, a display panel for the same, and a method of manufacture.

2. Description of the Related Art

A liquid crystal display generally includes two display panels having field generating electrodes and a liquid crystal layer having dielectric anisotropy interposed therebetween. The liquid crystal display induces an electric field in the liquid crystal layer by applying a varying voltage to the field generating electrodes to control the transmittance of light passing through the liquid crystal layer, thereby displaying a desired image.

Such a liquid crystal display generally has a structure formed of a switching display panel having a pixel electrode and a switching element, and a color filter array panel having a common electrode, a black matrix, and a color filter, with a liquid crystal layer interposed between the two panels.

The color filter array panel includes an insulation substrate and a black matrix formed on the insulation substrate for preventing light leakage. A plurality of color filters are formed in the pixel areas defined by the black matrix. The color filter panel includes a common electrode formed of a transparent conductive material such as indium tin oxide (ITO) and indium zinc oxide (IZO).

In order to fix the two display panels together and prevent leakage of the liquid crystals, both edges of the substrate are sealed with a sealant. The sealant overlaps a predetermined width of the black matrix.

Although a thermosetting material can be used as the sealant. However, when an ultraviolet ray thermosetting material is used for fast hardening, the ultraviolet rays cannot reach the sealant in regions blocked by the black matrix. Therefore, the sealant may not be completely hardened. When the sealant is not hardened, the sealant element may be eluted to the liquid crystal. The eluted sealant element pollutes the liquid crystal and may be absorbed to the alignment layer surface, thereby generating defects.

### SUMMARY OF THE INVENTION

According to the one aspect of the present invention, the polarization layer is used instead of a black matrix so that the ultraviolet rays are not blocked from hardening the sealant.

According to an exemplary embodiment of the present invention, a display panel includes a substrate, a polarization layer, and a color filter. The substrate includes a first side and a second side, a polarization layer and color filter both formed on the first side of the substrate.

The polarization layer may have a matrix pattern, and the polarization layer may be formed by coating a disk shaped lyotropic liquid crystal while applying a shear force.

The display panel may further include a common electrode covering the polarization layer and the color filter formed on the first side of the substrate.

According to another exemplary embodiment of the present invention, a liquid crystal display includes: a first substrate; a second substrate; a polarization layer; pluralities of switching elements and pixel electrodes; a common electrode; a liquid crystal; and a first polarizer. The second substrate includes an inner surface facing an inner surface of the first substrate separated by a predetermined distance, and the polarization layer is formed on one of the first substrate and the second substrate. The pluralities of switching elements and pixel electrodes are formed on one of the first substrate and the second substrate. The common electrode is formed on one of the first substrate and the second substrate. The liquid crystal is discharged between the first substrate and the second substrate, and the first polarizer is disposed at an outer side of the first substrate. Herein, a transmission axis of the polarization layer orthogonally crosses a transmission axis of the first polarizer.

The liquid crystal display may further include a second polarizer disposed at an outer side of the second substrate. The polarization layer may have a matrix pattern, and the polarization layer may be formed by coating disk shaped lyotropic liquid crystal while applying a shear force.

According to a further exemplary embodiment of the present invention, in a method of manufacturing a liquid crystal display, a polarization layer is formed on an inner side of a first insulation substrate. A plurality of thin films are formed on an inner side of the first insulation substrate, and a plurality of thin films are formed on an inner surface of the second insulation substrate. The first insulation substrate and the second insulation substrate are assembled with liquid crystal filled at a space formed by the first insulation substrate, the second insulation substrate, and a sealant. Then, the sealant is hardened by radiating ultraviolet rays on the sealant. A polarizer is arranged at one of the outer sides of the first insulation substrate and the second insulation substrate. In this method, a transmission axis of the polarizer orthogonally crosses a transmission axis of the polarization layer.

In forming the polarization layer on the inner side of the first insulation substrate, lyotropic liquid crystal may be coated on the inner side of the first insulation substrate not to break an arrangement while applying a shear force, and then dried.

According to yet another exemplary embodiment of the present invention, in a method of manufacturing a panel for a liquid crystal display, a liquid crystal material is dripped on a substrate, and a polarization layer is formed by distributing the liquid crystal material on the substrate through applying a predetermined pressure on the dripped liquid crystal material. Then, the polarization layer is patterned.

The liquid crystal material may be liquid phase lyotropic liquid crystal. In forming the polarization by distributing the dripped liquid crystal material through applying a predetermined pressure, a wire wound roller rod may be used. A diameter of the wire may be about 50 μm to 120 μm.

The dripping the liquid crystal material on the substrate, and the forming the polarization by distributing the dripped liquid crystal material through applying a predetermined pressure may be continuously progressed using a slot die coating apparatus including a container for storing liquid phase lyotropic liquid crystal, a pump for pumping the stored lyotropic liquid crystal, a slot for erupting the lyotropic liquid crystal using a pumping pressure of the pump, and a coating die for coating the lyotropic liquid crystal while applying a shear force.

The patterning the polarization layer may be progressed using an apparatus having a solution injection hole, a guide, and a solution discharge hole in which a solution is injected through the solution injection hole, the injected solution contacts the polarization layer in the guide, the contacted polarization layer is melted down, and the solution is discharged through the solution discharge hole.

The patterning the polarization layer may be progressed by radiating a laser.

In the patterning the polarization layer, a plurality of pixel areas may be simultaneously patterned.

### BRIEF DESCRIPTION OF THE DRAWINGS

FIG. 1 is a layout view of a liquid crystal display according to an exemplary embodiment of the present invention.

FIG. 2 is a cross-sectional view of FIG. 1 taken along the line II-II.

FIG. 3 is a schematic view of a polarization layer of a liquid crystal display according to an exemplary embodiment of the present invention.

FIG. 4 is a cross-sectional view of the liquid crystal display of FIG. 1 for describing a manufacturing method thereof.

FIG. 5 and FIG. 7 are top plan views of a polarization layer used in a liquid crystal display according to an exemplary embodiment of the present invention.

FIG. 6 and FIG. 8 are respectively cross-sectional views of FIG. 5 and FIG. 7.

FIG. 9 is an enlarged diagram of the roller rod shown in FIG. 7 and FIG. 8.

FIG. 10 is a cross-sectional view illustrating a method for forming a polarization layer used in a liquid crystal display according to another exemplary embodiment of the present invention.

FIG. 11 is a cross-sectional view of a polarization layer patterning apparatus according to an exemplary embodiment of the present invention.

FIG. 12 is a top view illustrating the polarization layer patterning apparatus of FIG. 11.

FIG. 13 is a diagram for illustrating a polarization layer patterning method using the polarization layer patterning apparatus of FIG. 11 and FIG. 12.

FIG. 14 is a schematic view of a pattern formed by the polarization layer patterning apparatus of FIG. 11 and FIG. 12.

FIG. 15 is a diagram illustrating a polarization layer patterning method according to another exemplary embodiment of the present invention.

FIG. 16 and FIG. 17 are microscopic pictures of a patterned polarization layer using the method of FIG. 15.

### DETAILED DESCRIPTION OF THE EMBODIMENTS

The present invention may, however, be embodied in many different forms and should not be construed as limited to the embodiments set forth herein.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Hereinafter, a liquid crystal display according to an exemplary embodiment of the present invention will be described with reference to the accompanying drawings.

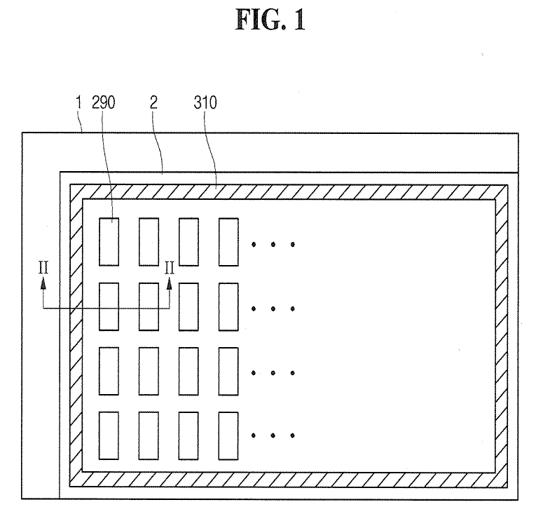

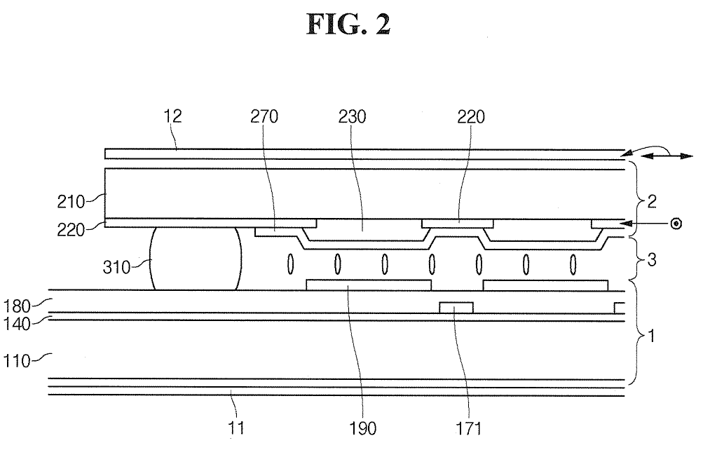

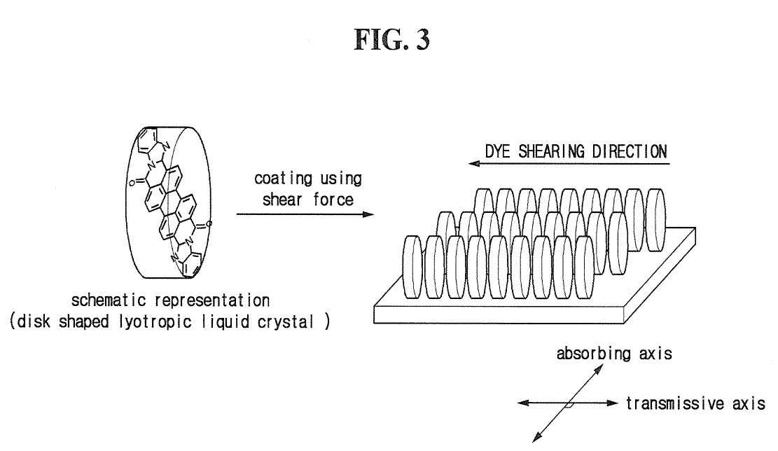

FIG. 1 is a layout view of a liquid crystal display according to an exemplary embodiment of the present invention, FIG. 2 is a cross-sectional view of FIG. 1 taken along the line II-II, and FIG. 3 is a schematic view of a polarization layer of a liquid crystal display according to an exemplary embodiment of the present invention.

As shown in FIG. 1 and FIG. 2, the liquid crystal display according 20 to an exemplary embodiment of the present invention includes an upper panel 2 and a lower panel 1 facing each other, and a liquid crystal layer 3 formed by injecting liquid crystal therebetween. A lower polarizer 11 is disposed under the lower panel 1, and an upper polarizer 12 is disposed on the upper panel 2.

The lower panel 1 is a display panel for controlling the liquid crystal by each pixel. The lower panel 1 includes an insulation substrate 110, and a gate line (not shown), a data line 171, a plurality of pixel electrodes 190, and a plurality of thin film transistors (not shown) as switching elements, formed on the substrate 110. The lower panel 1 also includes a gate insulation layer 140 for insulating the gate line from the data line 171 and a passivation layer 180 covering the thin film transistors for insulating 10 the pixel electrodes 190 from the data line 171. Each thin film transistor is a three terminal element including a gate electrode (not shown), a source electrode (not shown), and a drain electrode (not shown), and is formed of a semiconductor forming a current channel.

The upper panel 2 is a display panel for expressing colors and includes an insulation substrate 210, and a polarization layer 220 formed in a matrix pattern to prevent light leakage. A color filter 230 is formed in a pixel area defined by the polarization layer 220. A common electrode 270, formed of a transparent conductive material such as an indium tin oxide (ITO) or indium zinc oxide (IZO), is formed on the color filter 230.

A sealant 310 is formed on the circumference of a display area between the two display panels for fixing the two display panels 1 and 2 and confining the liquid crystal layer 3.

The polarization layer 220 may be formed in a stripe pattern if desired.

The polarization layer 220 passes light elements that are parallel with its transmission axis and blocks light elements that are normal to its transmission axis. The transmission axis of the polarization layer 220 is disposed to be normal with respect to the transmission axis of the upper polarizer 12.

When the ultraviolet rays are are used to harden the sealant 310 after assembling the upper panel 2 and the lower panel 1, ultraviolet ray elements parallel with the transmission axis of the polarization layer 220 harden the sealant 310 after passing through the polarization layer 220. Polarized ultraviolet rays may be used to improve the hardening rate of the sealant 310.

After attaching the lower and upper polarization plates 11 and 12, light passing through the region where the polarization layer 220 is formed is completely blocked. That is, the polarization layer 220 functions as a black matrix. Since the polarization layer 220 is disposed to have the transmission axis normal to the transmission axis of the upper polarizer 12, the light is absorbed while it passes through the polarization layer 220 and the upper polarizer 12.

In present embodiment, the upper polarizer 12 is disposed to have the transmission axis normal to the transmission axis of the polarization layer 220. However, the lower polarizer 11 may be disposed to have the transmission axis normal to the transmission axis of the polarization layer 220 if desired so that the light does not also pass through the region where the polarization layer 220 is formed. In this case, the light polarized while passing through the lower polarizer 11 is blocked by the polarization layer 220.

The polarization layer 220 of the liquid crystal display according to an exemplary embodiment of the present invention is manufactured by coating liquid crystal material. The method of manufacturing the polarization layer 220 according to an embodiment of the present invention will be described with reference to FIG. 3.

FIG. 3 is a schematic view illustrating a polarization layer of a liquid crystal display according to an exemplary embodiment of the present invention.

As shown in FIG. 3, a disk type lyotropic liquid crystal is used as the raw material of polarization layer 220. For example, the disk type lyotropic liquid crystals are materials expressed by the following structural formulae.

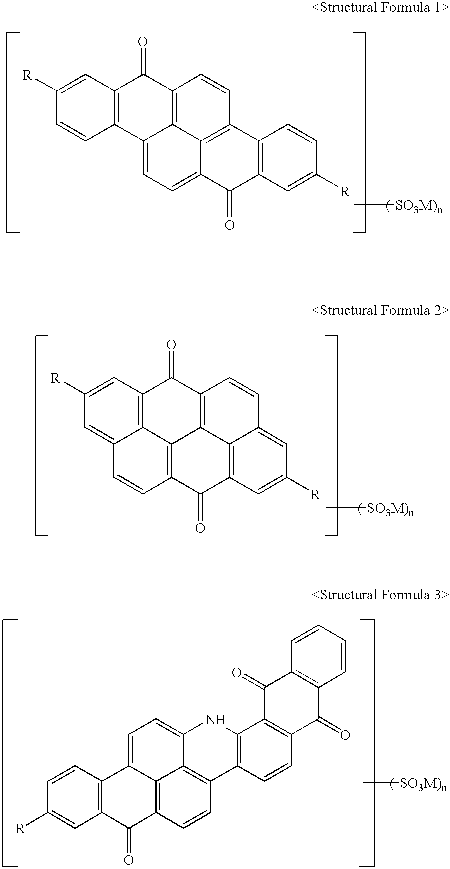

As shown in FIG. 3, such a disk shaped lyotropic liquid crystal is coated while applying a shear force, and then the coated lyotropic liquid crystal is dried, thereby forming a layer having polarity. Then, the layer with polarity is patterned by using a predetermined method, thereby forming a polarization layer 220 with a pattern such as a matrix or a stripe.

As shown in FIG. 3, in the polarization layer 220, the disk shaped lyotropic liquid crystals are arranged to have the normal lines of disks parallel to each other and to form a plurality of disk rows.

Hereinafter, a manufacturing method of a liquid crystal display according to an exemplary embodiment of the present invention will be described.

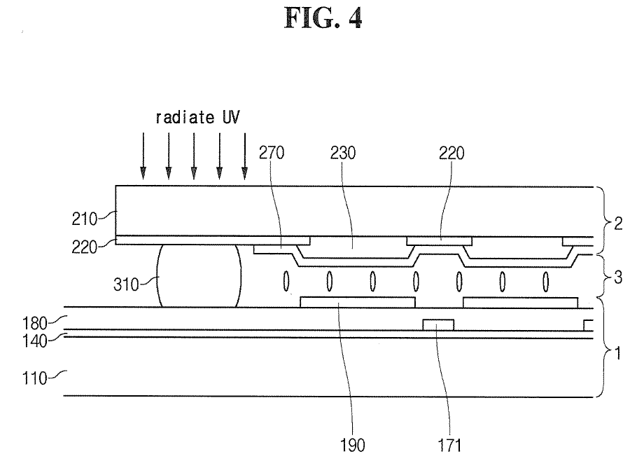

FIG. 4 is a cross-sectional view illustrating one step in a manufacturing method of the liquid crystal display of FIG. 1.

At first, a method for manufacturing the lower panel 1 will be described.

A thin film layer is formed on an insulation substrate 110. Then, a gate line, a gate insulating layer 140, and a data line 171 are formed by repeatedly patterning the thin film layer through various methods, such as photolithography. Simultaneously, a thin film transistor formed of a gate electrode, a source electrode, a drain electrode, and a semiconductor, and also a pixel electrode are formed, thereby forming the lower panel 1.

Hereinafter, a method of manufacturing the upper panel 2 will be described.

A polarization layer 220 is formed by coating lyotropic liquid crystal on the insulation substrate 210 while applying a shear force and patterning the coated lyotropic liquid crystal layer using a predetermined method. Color filters 230 are formed at each pixel area defined by the polarization layer 220. Each of the color filters 230 is formed by coating a photoresist having a pigment on the polarization layer 220, and repeatedly performing an exposure and development process for red, green, and blue colors. Then, a common electrode 270 is formed on the color filters 230 by depositing a transparent conductive material, such as ITO and IZO.

Although the method of manufacturing the lower panel 1 and the upper panel 2 of a liquid crystal display according to an exemplary embodiment of the present invention includes many manufacturing processes, such as a liquid crystal alignment layer forming process, etc., those processes are omitted for simplifying the description of the present invention and for helping to understand the present invention.

A sealant 310 is coated on one of the lower panel 1 and the upper panel 2, and a storage space formed by the sealant 310 is filled with liquid crystal by dripping the liquid crystal therein. Then, the two display panels 1 10 and 2 are coupled.

Then, the sealant 310 is hardened by radiating ultraviolet rays through the upper panel 2, as shown in FIG. 4. Since the polarization layer 220 substitutes as the block matrix, the entire area of the sealant 310 receives the ultraviolet rays. Therefore, the entire area of the sealant 310 is hardened.

Then, polarizers 11 and 12 are disposed at the outer surfaces of the lower and upper panels 1 and 2. Herein, the upper polarizer 12 is disposed to have a transmission axis orthogonally crossing the transmission axis of the polarization layer 220. If desired, the lower polarizer 11 may be disposed to have a transmission axis orthogonally crossing the transmission axis of the polarization layer 220. In the case of a reflective liquid crystal display, the lower polarizer 11 need not be disposed.

Hereinafter, a method of forming a polarization layer that substitutes as a black matrix in a liquid crystal display according to an exemplary embodiment of the present invention will be described with reference to the accompanying drawings.

A method of coating a polarization layer on a substrate will be described.

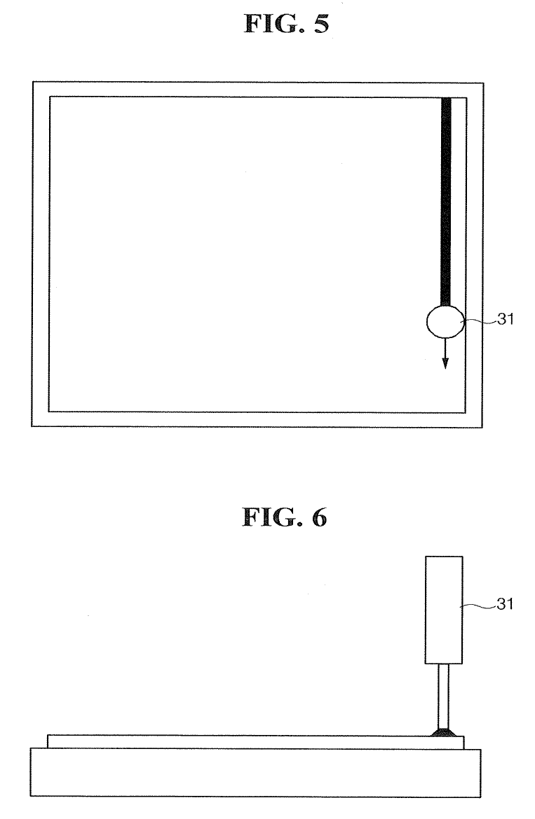

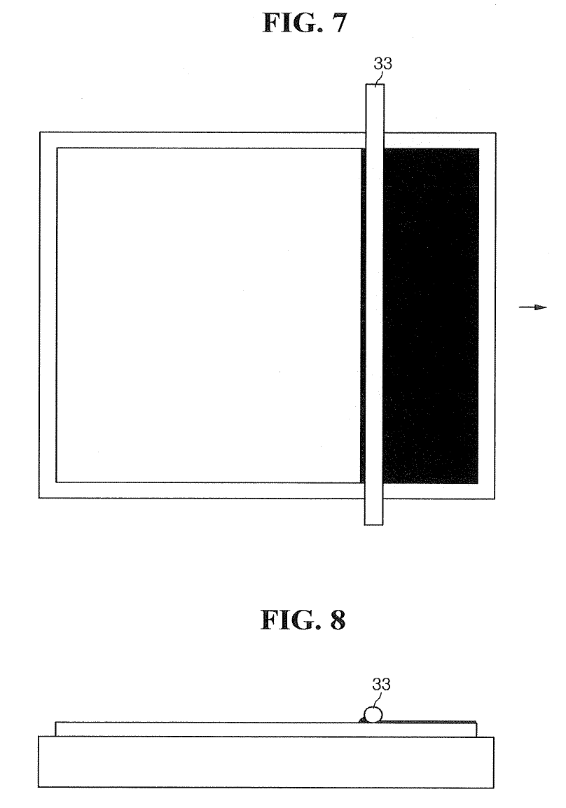

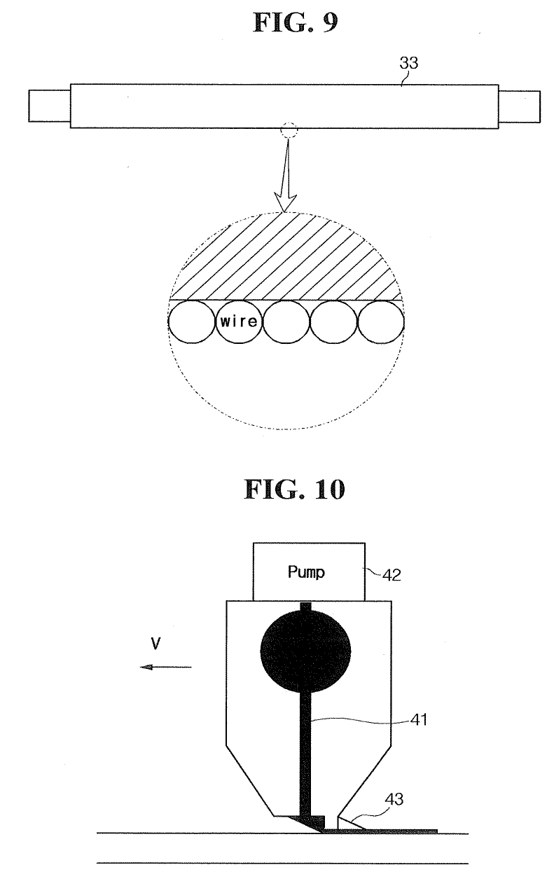

FIG. 5 and FIG. 7 are top plan views illustrating a method of manufacturing a polarization layer used in a liquid crystal display according to an exemplary embodiment of the present invention, FIG. 6 and FIG. 8 are cross-sectional views corresponding to FIG. 5 and FIG. 7, and FIG. 9 is a diagram illustrating the roller rod shown in FIG. 7 and FIG. 8.

As show in FIG. 5 and FIG. 6, liquid lyotropic liquid crystal is dripped on the substrate 210 using a nozzle 31.

Then, the dripped lyotropic liquid crystal is coated on the substrate 210 while applying a shear force to the dripped lyotropic liquid crystal using a roller rod 33 as shown in FIG. 7 and FIG. 8. As shown in FIG. 9, since a fine wire is wound about the roller rod 33, the shear force is generated to arrange the lyotropic liquid crystal with constant directivity. The layer quality of the polarization layer can be controlled by the coating speed and a diameter of the fine wire. In general, the diameter of the fine wire is about 50 μm to 120 μm.

FIG. 10 is a cross-sectional view illustrating a method of manufacturing a polarization layer used in a liquid crystal display according to another exemplary embodiment of the present invention.

As another method for coating a polarization layer, as shown in FIG. 10, a polarization layer can be manufactured using a slot die coating apparatus including a container for storing liquid phase lyotropic liquid crystal, a pump 42 for pumping the stored lyotropic liquid crystal, a slot 41 for discharging the lyotropic liquid crystal using a pumping pressure, and a coating die 43 for coating the lyotropic liquid crystal while applying a shear force. If the slot die coating apparatus is used, injection and coating of the liquid crystal can be progressed continuously. The quality of the polarization layer is controlled by controlling the quantity of liquid crystal to be coated, the gap between the substrate and the coating die 43, and the coating speed.

Now, a method of patterning the coated polarization layer will be described.

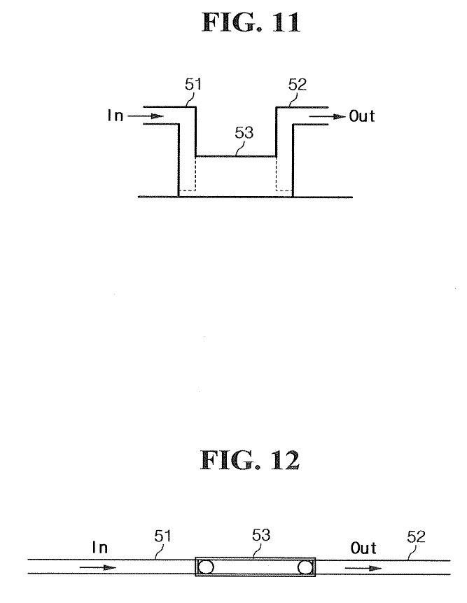

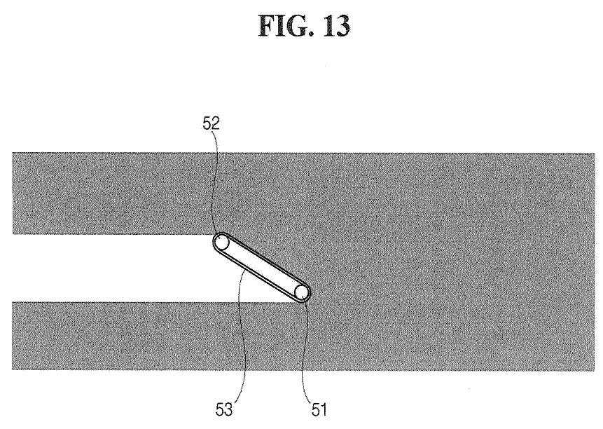

FIG. 11 is a cross-sectional view of a patterning apparatus according to an exemplary embodiment of the present invention, FIG. 12 is a top view of the patterning apparatus shown in FIG. 11, and FIG. 13 is a drawing illustrating a method of patterning a polarization layer using the apparatus shown in FIG. 11 and FIG. 12.

As shown in FIG. 11 and FIG. 12, the polarization layer patterning apparatus includes a solvent injection hole 51, a solvent discharge hole 52, and a guide 53. The guide 53 has an open bottom side for allowing a solvent to contact the polarization layer while the solvent passes through the guide 53. In such a solvent injection type polarization layer patterning apparatus, a solvent that melts the polarization layer is injected through the injection hole 51 and the polarization layer is melted in the guide 53. After melting the polarization layer, the solvent is vacuum-inhaled and discharged through the solvent discharge hole 52. As the solvent, ultra pure water, or alcohol such as methanol, ethanol, and propanol can be used.

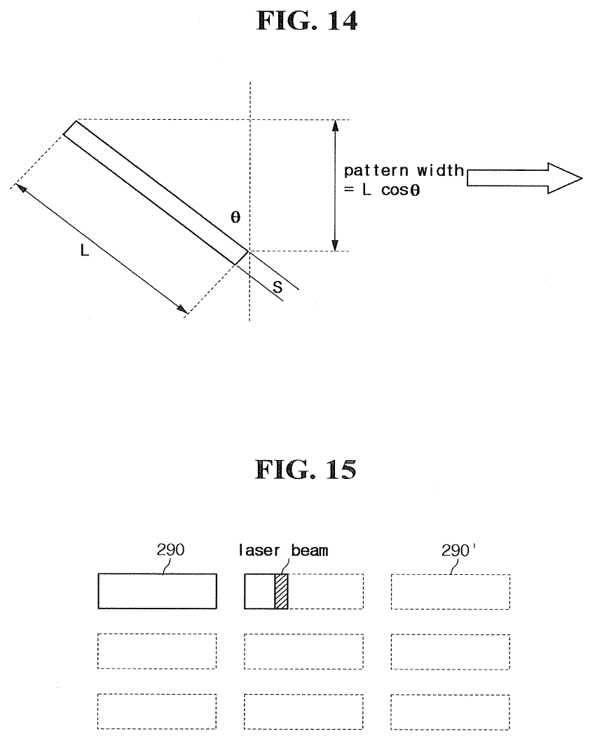

As shown in FIG. 13, the width of the pattern of removing the polarization layer is determined by controlling a tilt angle of the guide 53 from a progression direction in the case of using the solvent injection type polarization layer patterning apparatus. Next, a liquid crystal display according to an exemplary embodiment of the present invention will be described in detail with reference to FIG. 14.

FIG. 14 is a schematic view illustrating a pattern formed by using the apparatus of FIG. 11 and FIG. 12.

As shown in FIG. 14, when a width of a guide is S, a length is L, and an angle formed between the guide and a vertical to the progression direction is θ, the pattern width formed by removing the polarization layer is L cos θ. The minimum pattern width W is S and is obtained when the guide progresses in its length direction, and the maximum pattern width W is L, which is obtained when the guide is vertical to the progression direction.

The polarization layer is completely manufactured by performing a drying and solidification process on the patterned polarization layer.

As described above, the polarization layer substituting a black matrix is manufactured by coating, patterning using a solvent, and solidification through drying in the present embodiment. Therefore, equipment and material cost can be reduced compared to the method of forming a black matrix through metal deposition and photolithography.

FIG. 15 is a diagram illustrating a method of patterning a polarization layer according to another exemplary embodiment of the present invention.

A laser is used in the method of patterning a polarization layer according to another exemplary embodiment of the present invention.

A coated polarization layer is dried and solidified using the method shown in FIG. 5 to FIG. 8, or the method shown in FIG. 10. The polarization layer is detached from a pixel area by making the cross-section of the laser beam to be close to a rectangle and scanning a predetermined pixel area using the laser. The separated polarization layer is removed using a vacuum-inhale device. In FIG. 15, a region 290 drawn with a solid line denotes a region with a polarization layer removed using a laser and a region 290′ drawn with a doted line denotes a pixel area to have a polarization layer removed therefrom. When radiating a laser, a pixel area to have a polarization layer removed therefrom can be assigned by setting a coordinate into a laser radiating device.

There are two mechanisms for removing a polarization layer when a laser is radiated to remove the polarization layer. In the first mechanism, the polarization layer is melted by heat generated from the laser. In the second mechanism, the particles of the polarization layer are separated from the polarization layer by the impact made by the laser. Both mechanisms can be applied to the present invention.

A plurality of pixel areas may be simultaneously patterned by making the cross-section of the laser beam lengthily, and dividing the laser beam into a plurality of beams using a mask. Also, a plurality of pixel areas may be simultaneously patterned using a plurality of laser beams.

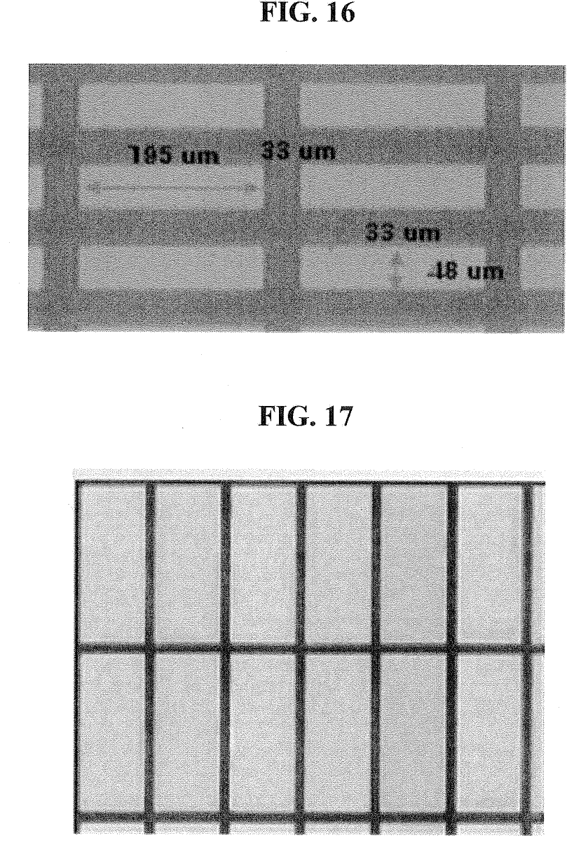

FIG. 16 and FIG. 17 are microscopic pictures of a patterned polarization layer using the method of FIG. 15.

FIG. 16 is a microscopic picture of a patterned polarization layer using an excimer laser. The polarization layer is patterned using a 248 nm wavelength of an ultraviolet ray excimer laser and about 50 mJ/cm² to 300 mJ/cm² of laser energy. In this condition, the pattern can be formed at a size of about 1 μm to several tens of μm. It takes about 100 seconds to pattern a 17 inch panel using such an excimer laser.

FIG. 17 is a microscopic picture of a polarization layer patterned using a Diode-Pumped Solid-State (DPSS) YAG laser. The polarization layer is patterned using about a 1064 nm wavelength of YAG laser and about 400 mJ/cm² to 600 mJ/cm² of laser energy. In this condition, the pattern is formed at a size of about 1 μm to several tens of μm. In this picture, the size of a pixel area with a polarization layer removed is about 200 μm*70 μm, and the width of the remaining polarization layer between the pixel areas is about 5 μm. It takes about 40 seconds to pattern a 17 inch panel using such a YAG laser.

A resolution, which is the minimum width of a pattern formed by using such a laser, can be expressed by the following equation.

Resolution=0.5*λ/NA [λ: wavelength, NA: numerical aperture, characteristic value of laser's output lens]

Accordingly, a pattern having a width of about 1 μm to 2 μm can be formed using the excimer laser, and a pattern having a width of about 5 μm can be formed using the YAG laser.

As described above, a high density pattern can be formed using a laser to pattern the polarization layer. Also, it makes related processes simpler and improves the productivity.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

In the present invention, the polarization layer substitutes for the black matrix for a predetermined polarization element of ultraviolet rays to reach a sealant when the ultraviolet rays are radiated to harden the sealant. Therefore, the sealant can be sufficiently hardened. Also, the polarization layer functions as a black matrix by cooperating with upper and lower polarizers when a liquid crystal display is used, thereby preventing display quality deterioration.

What is claimed is:

1. A display panel comprising:
a substrate having a first side and a second side;
a polarization layer formed on the first side of the substrate; and
a color filter formed on the first side of the substrate.

2. The display panel of claim 1, wherein the polarization layer has a matrix pattern.

3. The display panel of claim 1, wherein the polarization layer is formed by coating a disk shaped lyotropic liquid crystal while applying a shear force.

4. The display panel of claim 1, further comprising a common electrode covering the polarization layer and the color filter formed on the first side of the substrate.

5. A liquid crystal display comprising:
a first substrate,
a second substrate having an inner surface facing an inner surface of the first substrate separated by a predetermined distance;
a polarization layer formed on one of the first substrate and the second substrate;
pluralities of switching elements and pixel electrodes formed on one of the first substrate and the second substrate;
a common electrode formed on one of the first substrate and the second substrate;
a liquid crystal interposed between the first substrate and the second substrate; and
a first polarizer disposed at an outer side of the first substrate, wherein a transmission axis of the polarization layer orthogonally crosses a transmission axis of the first polarizer.

6. The liquid crystal display of claim 5, further comprising a second polarizer disposed at an outer side of the second substrate.

7. The liquid crystal display of claim 5, wherein the polarization layer has a matrix pattern.

8. The liquid crystal display of claim 5, wherein the polarization layer is formed by coating disk shaped lyotropic liquid crystal while applying a shear force.

9. A method of manufacturing a liquid crystal display comprising:
forming a polarization layer on an inner side of a first insulation substrate;
forming a plurality of thin films on an inner side of the first insulation substrate;
forming a plurality of thin films on an inner surface of a second insulation substrate;
assembling the first insulation substrate and the second insulation substrate with liquid crystal filled at a space formed by the first insulation substrate, the second insulation substrate, and a sealant;
hardening the sealant by radiating ultraviolet rays on the sealant;
disposing a polarizer at one of the outer sides of the first insulation substrate and the second insulation substrate,
wherein a transmission axis of the polarizer orthogonally crosses a transmission axis of the polarization layer.

10. The method of claim 9, wherein, in the forming the polarization layer on the inner side of the first insulation substrate, lyotropic liquid crystal is coated on the inner side of the first insulation substrate while applying a shear force not to break an arrangement, and then dried.

11. A method of manufacturing a panel for a liquid crystal display comprising:
dripping a liquid crystal material on a substrate;
forming a polarization layer by distributing the liquid crystal material on the substrate through applying a predetermined pressure on the dripped liquid crystal material; and
patterning the polarization layer.

12. The method of claim 11, wherein the liquid crystal material is liquid phase lyotropic liquid crystal.

13. The method of claim 12, wherein, in forming the polarization by distributing the dripped liquid crystal material through applying a predetermined pressure, a wire wound roller rod is used.

14. The method of claim 13, wherein the diameter of the wire is about 50 μm to 120 μm.

15. The method of claim 12, wherein dripping the liquid crystal material on the substrate and forming the polarization layer by distributing the dripped liquid crystal material through applying a predetermined pressure are continuously progressed using a slot die coating apparatus including a container for storing liquid phase lyotropic liquid crystal, a pump for pumping the stored lyotropic liquid crystal, a slot for discharging the lyotropic liquid crystal using a pumping pressure of the pump, and a coating die for coating the lyotropic liquid crystal while applying a shear force.

16. The method of claim 11, wherein patterning the polarization layer is progressed using an apparatus having a solution injection hole, a guide, and a solution discharge hole in which a solution is injected through the solution injection hole, the injected solution contacts the polarization layer in the guide, the contacted polarization layer is melted down, and the solution is discharged through the solution discharge hole.

17. The method of claim 11, wherein patterning the polarization layer is progressed by radiating a laser.

18. The method of claim 17, wherein, in patterning the polarization layer, a plurality of pixel areas are simultaneously patterned.

19. A liquid crystal display comprising:
a pair of facing substrates;
a light-hardenable sealant bead disposed about the inner peripheries of the substrates;
a first polarization layer formed on an outer surface of a first one of the substrates and a second polarization layer formed on an inner surface of the first substrate, the second polarization layer being patterned to correspond to pixel transmission regions;
a third polarization layer formed on an outer surface of the second substrate, the transmission axis of the polarization layer orthogonally crossing a transmission axis of the first polarizer.
